(19) United States
(12) Patent Application Publication
(10) Pub. No.: US 2007/0052526 A1
(43) Pub. Date: Mar. 8, 2007

(54) Antitheft ignition lock structure for car

(76) Inventor: Ching Yuan Tsai, Xi-Zhi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/208,708

(22) Filed: Aug. 23, 2005

(51) Int. Cl. B60R 25/10

(52) U.S. Cl. 340/426.3

(57) ABSTRACT

An antitheft ignition lock structure for car includes two timing circuits, a monostable circuit, a non-stable circuit, an analog switch, and an RS flip-flop. The first timing circuit causes the monostable circuit to drive a relay for connecting to a voltage. The flip-flop is triggered through turning on and off the ignition lock. When the ignition lock is not turned off within a predetermined time after it is first turned on and then turned on for a second time, the engine of the car could not be started and the horn of the car would sound continuously as a warning to protect the car against theft.

### FIELD OF THE INVENTION

The present invention relates to an antitheft ignition lock structure for car, and more particularly to an antitheft structure for car, with which the engine of a car could not be started when the ignition lock is not turned off and then turned on again within a predetermined time after it is first turned on.

### BACKGROUND OF THE INVENTION

A thief trying to steal a car would usually use a special tool to turn on the ignition lock of the car and then start the engine. According to statistical data, the thief needs only ten seconds or so to complete the stealing. Once the ignition lock is successfully turned on to start the engine, a sound-producing alarm mounted on the car is completely useless in stopping the thief from driving the car away. Therefore, the best way of preventing the car from being stolen is to stop the thief from easily turning on the ignition lock and starting the engine.

### SUMMARY OF THE INVENTION

A primary object of the present invention is to provide an antitheft ignition lock structure for car that effectively stops a thief from easily starting the car engine and stealing the car.

To achieve the above and other objects, the antitheft ignition lock structure for car according to the present invention mainly includes two timing circuits, a monostable circuit, a non-stable circuit, an analog switch, and an RS flip-flop circuit. When the ignition lock of the car is first turned on, the first timing circuit starts 3-second timing and triggers the monostable circuit to enable a first relay and thereby supply a voltage to other circuits at a rear part of the antitheft structure. The ignition lock must be turned off within three seconds in order to trigger the flip-flop and enable a second relay to supply current to an engine ignition coil. Whereby, the engine could be started only when the ignition lock is turned on for a second time.

The second timing circuit starts 5-second timing when the ignition lock is first turned on. When the ignition lock is not turned off within three seconds after it is turned on for the first time, the engine could not be started and the second timing circuit would trigger the non-stable circuit to drive the horn of the car to continuously produce alternate long and short sounds as a warning.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the present invention; and

FIG. 2 is a circuit diagram of the present invention.

### DETAILED DESCRIPTION OF THE PREFERRED EMBODIMENTS

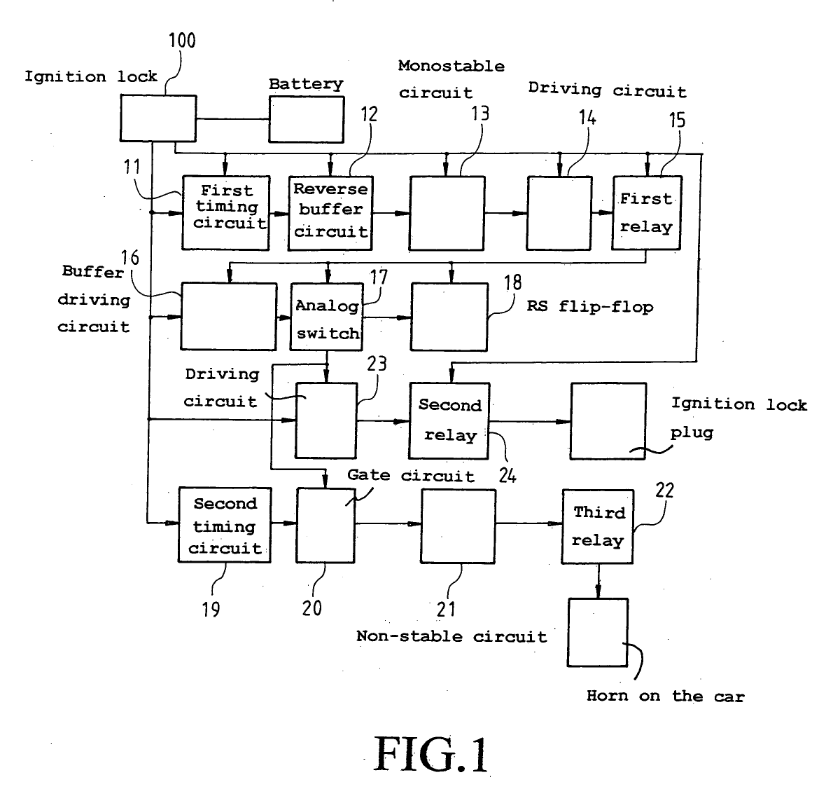

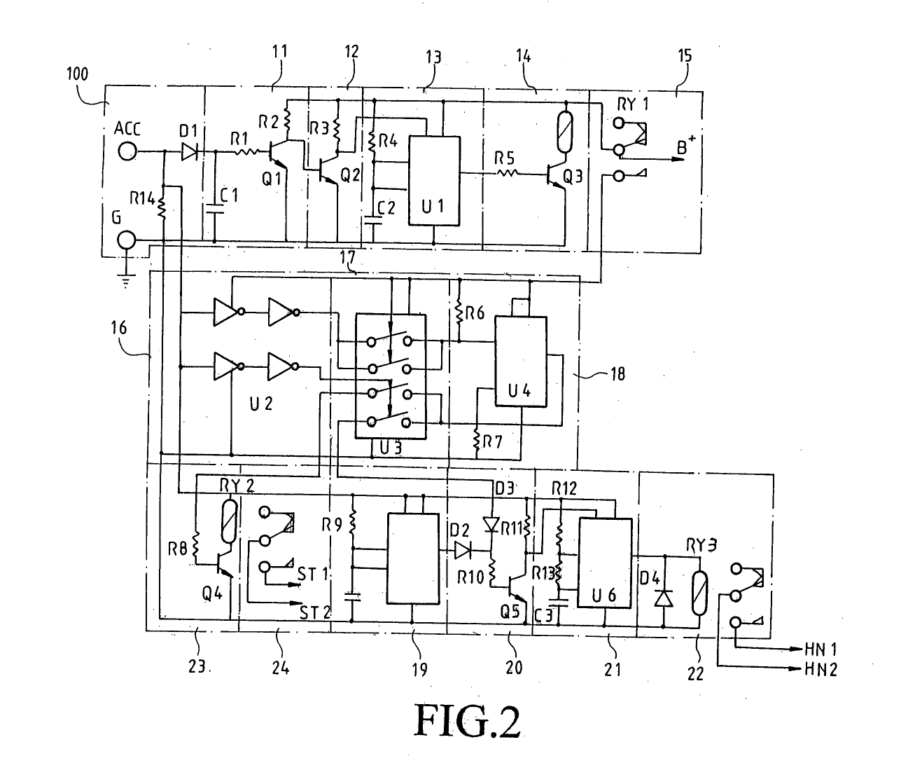

Please refer to FIGS. 1 and 2 that are block and circuit diagrams, respectively, of an antitheft ignition lock structure for car according to the present invention.

As shown, the present invention mainly includes a first timing circuit 11, a reverse buffer circuit 12, a monostable circuit 13, a driving circuit 14, and a first relay 15 connected to the driving circuit 14. The first timing circuit 11 is connected to an ignition lock 100 of a car, and the first relay 15 is connected at a normal opened contact to a positive voltage and to other circuits at a rear part of the antitheft structure of the present invention.

A buffer driving circuit 16 is connected at an input to the ignition lock 100, and at an output to a contact on an analog switch 17. The analog switch 17 is connected at another contact thereof to an RS flip-flop 18, and at a trigger end to the normal opened contact of the first relay 15.

A second timing circuit 19 is connected to a gate circuit 20, which is connected to a non-stable circuit 21, and the non-stable circuit 21 is connected to a third relay 22 with a normal opened contact thereof connected to a horn of the car.

A driving circuit 23 is connected to an output of the RS flip-flop 18, and to a second relay 24. The second relay 24 is then connected at a normal opened contact thereof to an engine ignition coil.

When the ignition lock 100 is first turned on, the first timing circuit 11 starts 3-second timing, and the first relay 15 is enabled via the monostable circuit 13 and the driving circuit 14. At this point, the ignition lock 100 must be turned off within three seconds, so that a negative pulse produced at the time of turning off the ignition lock 100 passes the buffer driving circuit 16 and the analog switch 17 to actuate the RS flip-flop 18, and the driving circuit 23 is triggered to enable the second relay 24 to supply current to the engine coil. That is, the engine is started only when the ignition lock 100 is turned on for the second time.

When the ignition lock 100 is turned off within three seconds but not turned on again, the monostable circuit 13 will disable the first relay 15 when the timing ends. And, the whole antitheft structure returns to an initial state thereof.

Meanwhile, when the ignition lock 100 is first turned on, the second timing circuit 19 also starts 5-second timing. If the ignition lock 100 is not turned off within three seconds, the second timing circuit 19 would drives the non-stable circuit 21 via the gate circuit 20, so that the third relay 22 is enabled and disabled for a long and a short time period, respectively, to drive the horn to sound continuously, and the engine could not be started to achieve the purpose of antitheft and warning.

In brief, the present invention uses timing circuits to cooperate with monostable and non-stable circuits as well as a flip-flop, so as to provide an antitheft ignition lock structure for a car.

What is claimed is:

1. An antitheft ignition lock structure for car, comprising:
a first timing circuit connected to an ignition lock of a car, an output of said first timing circuit being connected to a reverse buffer circuit and a monostable circuit, said monostable circuit being connected to a driving circuit that is further connected to a first relay, and said first relay being connected at a normal opened contact to a positive voltage and other circuits at a rear part of said antitheft structure, such that said first relay is enabled for a predetermined time when the ignition lock is turned on for the first time;
a buffer driving circuit connected at an input to the ignition lock, and at an output to an analog switch, said analog switch being connected at a trigger end to a contact on said first relay;
an RS flip-flop connected at a trigger end to a contact on said analog switch, and at an output to a second relay; and said second relay being connected at a normal opened contact to an engine coil of the car; and
a second timing circuit connected a gate circuit, said gate circuit being connected to a non-stable circuit, which is connected to a third relay; and said third relay being connected at a normal opened contact to a horn of the car;
whereby the engine of the car can be started only when said ignition lock is turned off within a predetermined time after it is first turned on, and then turned on for a second time; and the engine could not be started and the horn is driven to sound continuously as an antitheft warning when said ignition lock is not turned off within said predetermined time after being turned on for the first time.
